(19) United States
(12) Patent Application Publication
(10) Pub. No.: US 2012/0120068 A1
(43) Pub. Date: May 17, 2012

(54) DISPLAY DEVICE AND DISPLAY METHOD

(75) Inventors: Hisako Chiaki, Nara (JP); Katsuji Kunisue, Osaka (JP)

(73) Assignee: Panasonic Corporation, Osaka (JP)

(21) Appl. No.: 13/297,275

(22) Filed: Nov. 16, 2011

(30) Foreign Application Priority Data
Nov. 16, 2010 (JP) 2010-255501
Sep. 22, 2011 (JP) 2011-206781

(51) Int. Cl. G06T 15/00

(52) U.S. Cl. 345/419

(57) ABSTRACT

A display device includes an input unit, a depth direction position information processing unit, and a display processing unit. Depth direction position information is inputted to the input component. The depth direction position information is information corresponding to information about and/or the position in the depth direction of a subject. This depth direction position information is set for at least part of a two-dimensional information corresponding to a subject. The depth direction position information processing unit processes two-dimensional information. The two-dimensional information is made up of depth direction position information and either horizontal direction position information or vertical direction position information. The display processor displays an image corresponding to two-dimensional information processed by the depth direction position information processor.

### CROSS-REFERENCE TO RELATED APPLICATIONS

This application claims priority to Japanese Patent Application No. 2010-255501, filed on Nov. 16, 2010 and Japanese Patent Application No. 2011-206781, filed on Sep. 22, 2011. The entire disclosure of Japanese Patent Application No. 2010-255501 and Japanese Patent Application No. 2011-206781 are hereby incorporated herein by reference.

### BACKGROUND

1. Technical Field

The present technology relates to a display device that displays image information, and more particularly relates to a display device that displays depth direction position information expressing the positional relation in front of and behind a subject in a three-dimensional image. The present technology also relates to a display method that is executed by the above-mentioned display device.

2. Background Information

Display devices that display three-dimensional images (3D images), as well as imaging devices that capture these three-dimensional images, have been attracting attention in recent years. Many different display methods have been proposed, but they all share the same basic principle. This basic principle is that parallax is artificially created for the left and right eyes, so that the brain of the person viewing the image perceives a three-dimensional image.

When a three-dimensional image is captured, if the subject is located to close and there is too much parallax, the human brain cannot successfully blend the three-dimensional image, which makes the viewer feel that something is not right. Accordingly, when imaging is performed, depth direction position information expressing the convergence angle, the horizontal field of view, and/or the front and rear positional relation of the subject, etc., is adjusted so that there will not be a large parallax.

“Distance image” is a method for making depth direction position information visible with a two-dimensional display device. The primary display method for a distance image is a method in which pixels are expressed by hue on the basis of depth direction position information with respect to the pixels of the original image. In this case, for example, the hue of the pixels changes from a color with a high optical wavelength (red) to a color with a low optical wavelength (violet) as the position of the pixels moves from closer to farther away. There is another method, in which pixels are expressed by achromatic brightness (gray scale) on the basis of depth direction position information with respect to the pixels of the original image. In this case, for example, the brightness of the pixels changes from white (high brightness) to black (low brightness) as the position of the pixels moves from closer to farther away.

One method for displaying depth direction position information that has been disclosed involves choosing the orientation of various points on a surface from among three-dimensional shape data, and outputting the chosen orientations so that they can be identified (see Japanese Laid-Open Patent Application H6-111027). Here, the chosen orientations are expressed by the direction and length of line segments, or are expressed by the hue and saturation of colors.

With prior art, however, the above-mentioned distance image was produced and displayed by subjecting the original image to conversion processing. Depth information was ascertained by means of the hue, brightness, etc., of the distance image. However, even though viewers could get a physical sense of a certain position from the hue or brightness of a distance image, it was difficult to ascertain a certain position accurately. Thus, a problem with prior art was that information in the depth direction could not be accurately and easily recognized.

### SUMMARY

The present technology was conceived in an effort to solve the above problems encountered in the past. The display device disclosed herein comprises an input unit, a depth direction position information processing unit, and a display processing unit. Depth direction position information is inputted to the input unit. The depth direction position information corresponds to information about the depth direction of a subject and/or the position in the depth direction of the subject. The depth direction position information is set for at least part of a two-dimensional image corresponding to the subject. The depth direction position information processing unit is configured to process two-dimensional information. The two-dimensional information is made up of the depth direction position information and either horizontal direction position information or vertical direction position information. The horizontal direction position information corresponds to the position of the subject in the horizontal direction and is set for at least part of the two-dimensional image. The vertical direction position information corresponds to the position of the subject in the vertical direction and is set for at least part of the two-dimensional image. The display processing unit is configured to display an image corresponding to the two-dimensional information processed by the depth direction position information processing unit.

With the above constitution, information in the depth direction can be accurately and easily recognized. Also, object cropping adjustment of the display screen edges, reference plane adjustment, and so forth can be easily carried out on the basis of this information in the depth direction.

### BRIEF DESCRIPTION OF THE DRAWINGS

Referring now to the attached drawings, which form a part of this original disclosure:

FIG. 1 is a block diagram of an example of the configuration of a depth direction position information display device;

FIG. 2 is a flowchart of an example of the operation of a depth direction position information display device;

FIG. 3 is a diagram of an example of position information in the three-dimensional space of a subject in an embodiment;

FIG. 4 is a diagram of an example of a two-dimensional image of a subject in an embodiment;

FIG. 5 is a diagram of an example of a depth direction position information image in an embodiment;

FIG. 6 is a diagram of an example of a two-dimensional information of a subject in an embodiment;

FIG. 7 is a diagram of an example of a depth direction position information image in an embodiment;

FIG. 8 is a diagram of an example of a combined display image in an embodiment;

FIG. 9 is a diagram of an example of a combined display image in an embodiment;

FIG. 10 is a diagram of an example of a combined display image in an embodiment;

FIG. 11 is a diagram of an example of a combined display image in an embodiment;

FIG. 12 is a diagram of an example of a depth direction position information image in an embodiment;

FIG. 13 is a diagram of an example of a combined display image in an embodiment;

FIG. 14 is a diagram of an example of present technology in the three-dimensional space of a subject in an embodiment;

FIG. 15 is a diagram of an example of a two-dimensional image of a subject in an embodiment;

FIG. 16 is a diagram of an example of a depth direction position information image in an embodiment;

FIG. 17 is a diagram of an example of a combined display image in an embodiment;

FIG. 18 is a diagram of an example of a depth direction position information image in an embodiment; and

FIG. 19 is a diagram of an example of a depth direction position information image in an embodiment.

### DETAILED DESCRIPTION OF EMBODIMENTS

Selected embodiments of the present technology will now be explained with reference to the drawings. It will be apparent to those skilled in the art from this disclosure that the following descriptions of the embodiments of the present technology are provided for illustration only and not for the purpose of limiting the invention as defined by the appended claims and their equivalents.

### Embodiments

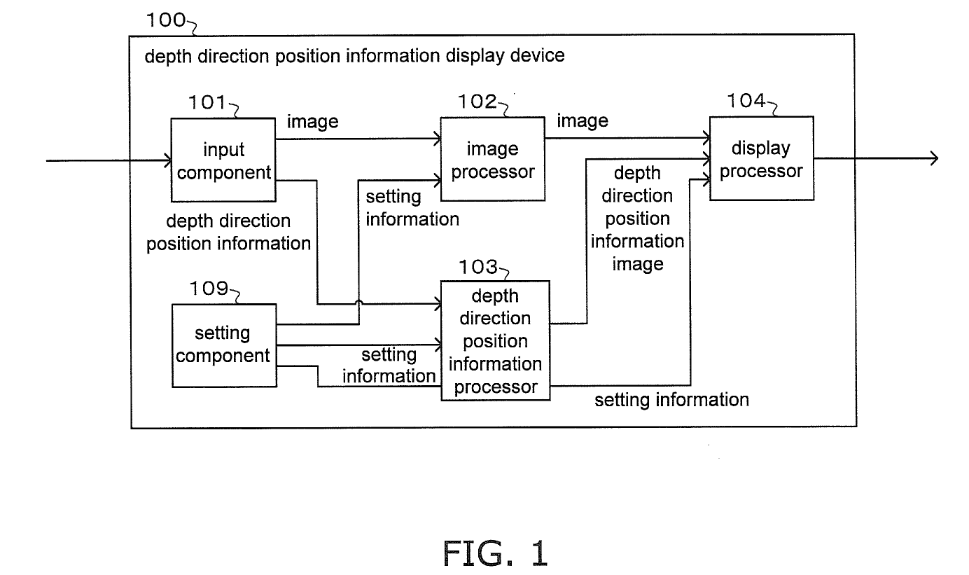

Embodiments will now be described through reference to the drawings. FIG. 1 is a block diagram of an example of the configuration of a depth direction position information display device in an embodiment. Terms such as “image,” “pixel,” “information,” “amount of parallax,” “distance,” and “coordinates” will be used below, but these terms will sometimes be used in the sense of “image data,” “pixel data,” “information data,” “amount of parallax data,” “distance data,” “coordinate data,” and so forth. Also, the term “image” will sometimes be used in the sense of “an image obtained by capturing an image of a subject.”

A depth direction position information display device 100 is made up of an input component 101, an image processor 102, a depth direction position information processor 103, a display processor 104, and a setting component 109.

Images and depth direction position information are inputted to the input component 101. The input component 101 then outputs the image to the image processor 102, and outputs the depth direction position information to the depth direction position information processor 103. The depth direction position information is set for at least part of the region (such as a subject, a block, a pixel, etc.) of an image in a two-dimensional plane when the image is expressed as a two-dimensional plane composed of a horizontal direction and a vertical direction.

The image inputted here (input image) is, for example, a still picture for each frame or for each field. The input image may also be continuous still pictures, for example. In this case, the input image is treated as a moving picture.

The input image includes, for example, a single image, a left-eye image and a right-eye image having binocular parallax, a three-dimensional image expressed by CG or another such surface model, and the like.

The depth direction position information includes, for example, the distance in the depth direction to the subject obtained by metering (depth coordinate), the amount of parallax between a left-eye image and a right-eye image having binocular parallax, coordinates indicating position information in a three-dimensional space for each apex of a model or texture information in a three-dimensional image, and the like. The amount of parallax corresponds, for example, to the amount of change in position information in the horizontal direction in regions corresponding to a left-eye image and a right-eye image.

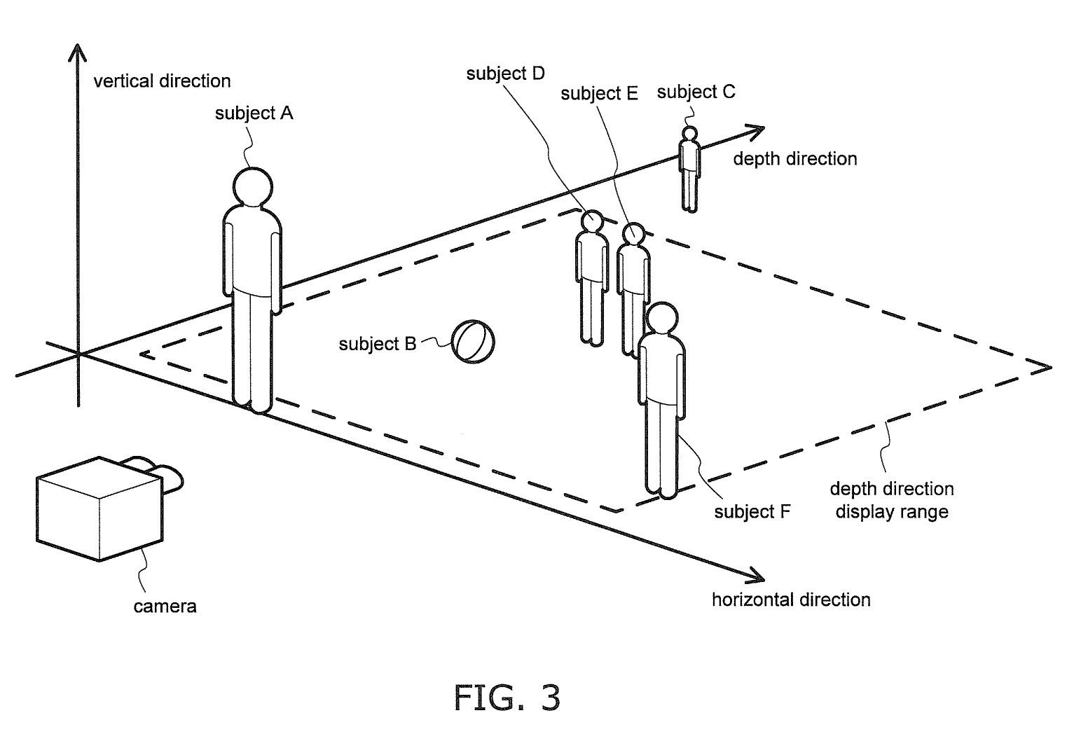

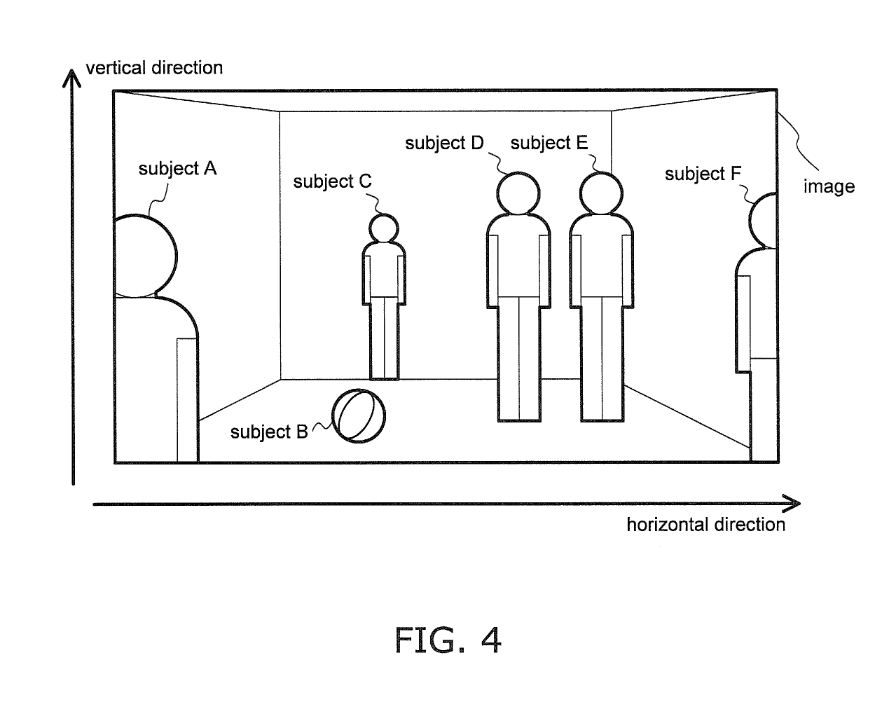

The following is a description of a mode in which depth direction position information is set on the basis of an input image. First, a mode will be described in specific terms in which the distance in the depth direction is calculated on the basis of a single image. The camera shown in FIG. 3 is able to measure the distance to the subjects from the camera, and the image. When subjects are imaged with this camera as shown in FIG. 3, for example, the single image is a two-dimensional image whose reference directions are the horizontal direction and the vertical direction, as shown in FIG. 4. Also, in this case the distance in the depth direction to each subject is, for example, a measured distance obtained by measuring for at least part of the region of each subject.

Next, a mode in which the amount of parallax is set on the basis of a left-eye image and a right-eye image having binocular parallax will be described in specific terms. When the subjects shown in FIG. 3 are imaged with a two-lens type of camera, the left-eye image and right-eye image having binocular parallax become a two-dimensional image whose reference directions are the horizontal direction and the vertical direction, respectively. In this case, for example, the regions mutually corresponding to the left-eye image and the right-eye image are detected. Block matching is then performed in the blocks including these regions. The amount of parallax for each region of the image, such as the amount of change (number of pixels) in present technology in the horizontal direction, is calculated. The ratio of the amount of change in the present technology to the horizontal size of the image as a whole is set as depth direction position information.

In the following description, a plane in which the left-eye image and the right-eye image coincide, that is, a plane with no binocular parallax made up of the horizontal direction and the vertical direction, is defined as the reference plane. For example, the plane in which the parallax is zero is calculated on the basis of the left-eye image and the right-eye image, and this plane is set as the reference plane. For instance, when an image is captured using a two-lens camera, the positional relation between the various subjects can be ascertained from this reference plane, which makes it easier for three-dimensional imaging to be performed. The phrases “a plane with no binocular parallax” and “the plane in which the parallax is zero” here include the meaning of “a plane in which binocular parallax is within a specified range of error” and “a plane in which parallax is within a specified range of error using zero as a reference.”

Finally, a mode will be described in specific terms in which coordinates indicating position information about the three-dimensional space for each apex in CG or another such surface model are set on the basis of a three-dimensional image expressed by this model. When the subjects shown in FIG. 3 are expressed by a surface model, the image is, for example, a two-dimensional image in which the horizontal direction and vertical direction are used as references, and in which the position of the camera is the perspective. Also, depth direction position information becomes, for example, coordinates indicating position information in a three-dimensional space for each apex of the model, when the position of the camera is the perspective. The image may hold information in the state of a three-dimensional image, and the perspective may be converted by subsequent processing.

The setting component 109 performs settings related to the display of depth direction position information. The setting component 109 outputs corresponding setting information to the image processor 102, the depth direction position information processor 103, and the display processor 104. Settings related to the display of depth direction position information include the following, for example.

(1) Setting of Depth Direction Position Information Serving as a Reference, Namely, Reference Plane Position Information (such as the Parallax Measurement Start Position, and a Position with no Binocular Parallax)

Depth direction position information that will serve as a reference, that is, reference plane position information, may be set on the basis of actual measurement, or may be set by relative calculation from an image. For instance, when the subjects shown in FIG. 3 are imaged with a camera that can measure the distance from the camera to the subjects, information indicating the position of the camera is set as reference plane position information. When reference plane position information is thus set, the reference plane is set on the basis of this reference plane position information.

In another mode, information indicating the position where there will be no binocular parallax in the display of a three-dimensional image is set as reference plane position information. For instance, when the subjects shown in FIG. 3 are imaged with a two-lens camera, in the mode described above for the setting of the amount of parallax, information form defining a region of no binocular parallax is set as reference plane position information. Furthermore, for example, when the subjects shown in FIG. 3 are expressed as a surface model, information for defining a plane with no parallax between the left-eye image and the right-eye image in the display of a three-dimensional image is set as reference plane position information. When reference plane position information is thus set, the reference plane is set on the basis of this reference plane position information.

(2) Setting of Position Information (Horizontal Direction Position Information or Vertical Direction Position Information) used Along with Depth Direction Position Information

Horizontal direction position information and vertical direction position information are information for defining the position of the image in the horizontal direction (horizontal coordinate) and the position in the vertical direction (vertical coordinate). When the image is expressed as a two-dimensional plane composed of the horizontal direction and the vertical direction, the horizontal direction position information and vertical direction position information are set for at least a partial region (such as a subject, a block, a pixel, etc.) of the image on the two-dimensional plane (two-dimensional image).

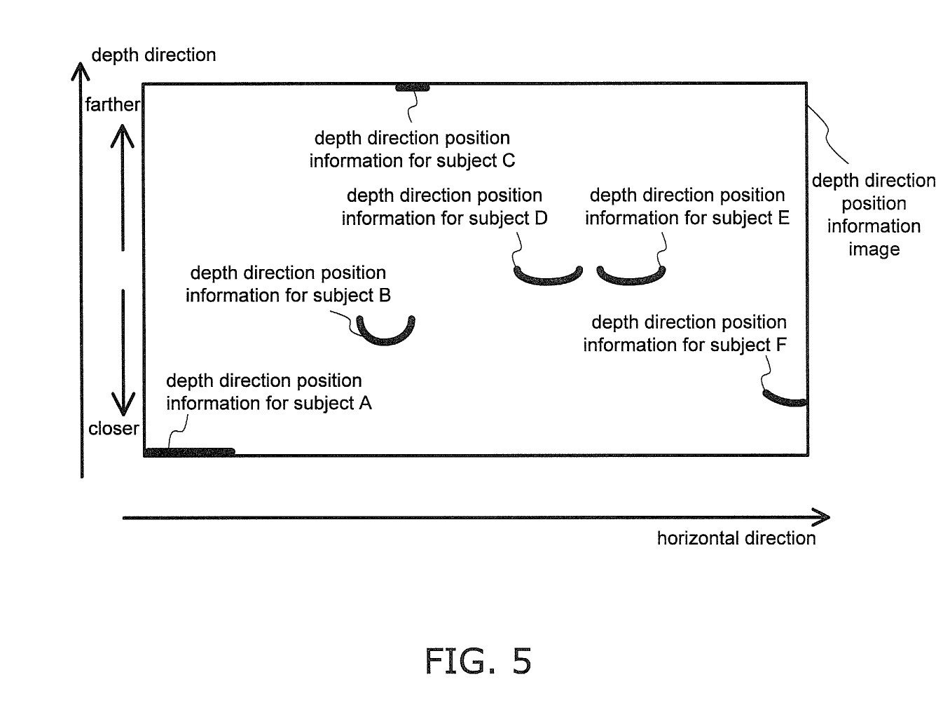

Here, the horizontal direction position information or depth direction position information is selected in order to display a depth direction position information image. For example, the depth direction position information image for the subjects shown in FIG. 3 is displayed as shown in FIG. 5 using horizontal direction position information and depth direction position information. More specifically, horizontal direction position information and depth direction position information are plotted on a two-dimensional graph to produce the depth direction position information image shown in FIG. 5. This allows the depth direction position relation and horizontal direction position relation between subjects to be easily ascertained. With this depth direction position information image (two-dimensional graph), the horizontal axis is set in the horizontal direction, and the vertical axis is set in the depth direction.

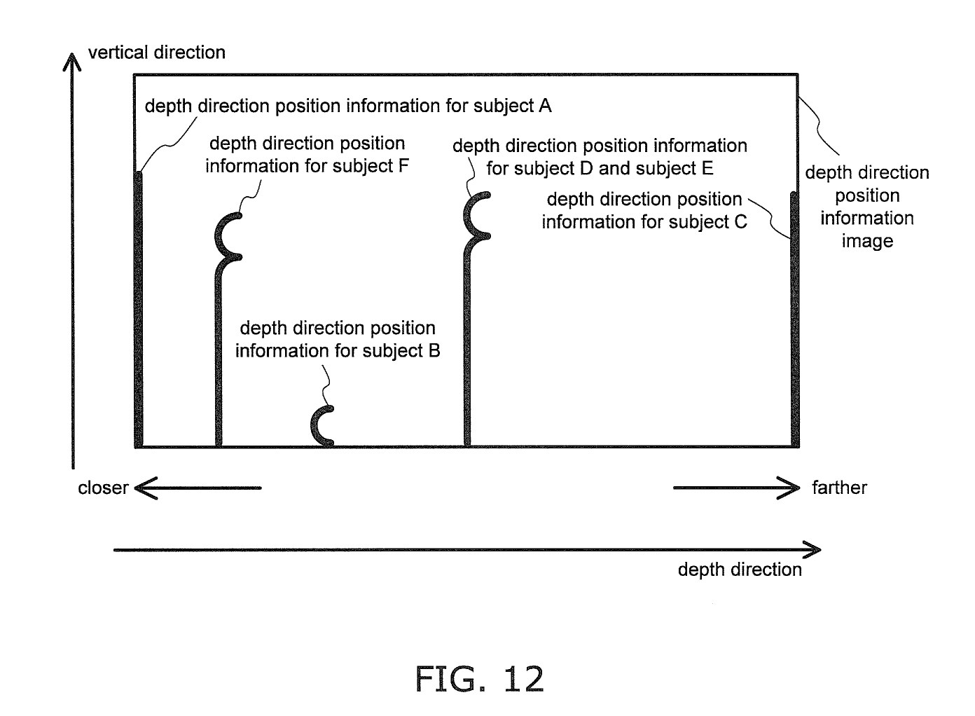

Also, the depth direction position information image for the subjects shown in FIG. 3 is shown in FIG. 12, using vertical direction position information and depth direction position information. More specifically, vertical direction position information and depth direction position information are plotted on a two-dimensional graph to produce the depth direction position information image shown in FIG. 12. This allows the depth direction position relation and vertical direction position relation between subjects to be easily ascertained. With this depth direction position information image (two-dimensional graph), the horizontal axis is set in the depth direction, and the vertical axis is set in the vertical direction. In this case, subjects D and E are shown overlapping because they have the same depth direction position information.

When an image has three-dimensional information, the perspective position may be changed. For example, when the perspective position is changed, the above-mentioned processing may be performed using horizontal direction position information after the change in perspective position, vertical direction position information after the change in perspective position, and depth direction position information after the change in perspective position.

Thus, the positional relation between subjects can be confirmed from various perspectives by using horizontal direction position information and vertical direction position information to display the depth direction position information. Specifically, the positional relation between the subjects during three-dimensional imaging can be ascertained, and three-dimensional imaging can be easily carried out.

(3) Setting the Range of the Depth Direction for the Displayed Depth Direction Position Information

Here, the display range of the depth direction position information is set. For example, when the display range for depth direction position information (the broken line in FIG. 3) is set for the subjects shown in FIG. 3, depth direction position information for subjects outside that display range (subjects A and C in FIG. 3) is set for non-display.

In another mode, the depth direction position information may be converted so that the depth direction position information for subjects outside the display range (subjects A and C in FIG. 3) will fall within the display range. In this case, for example, as shown in FIG. 5, the depth direction position information for subject A is displayed on the lower edge of the display range, while the depth direction position information for subject C is displayed on the upper edge of the display range.

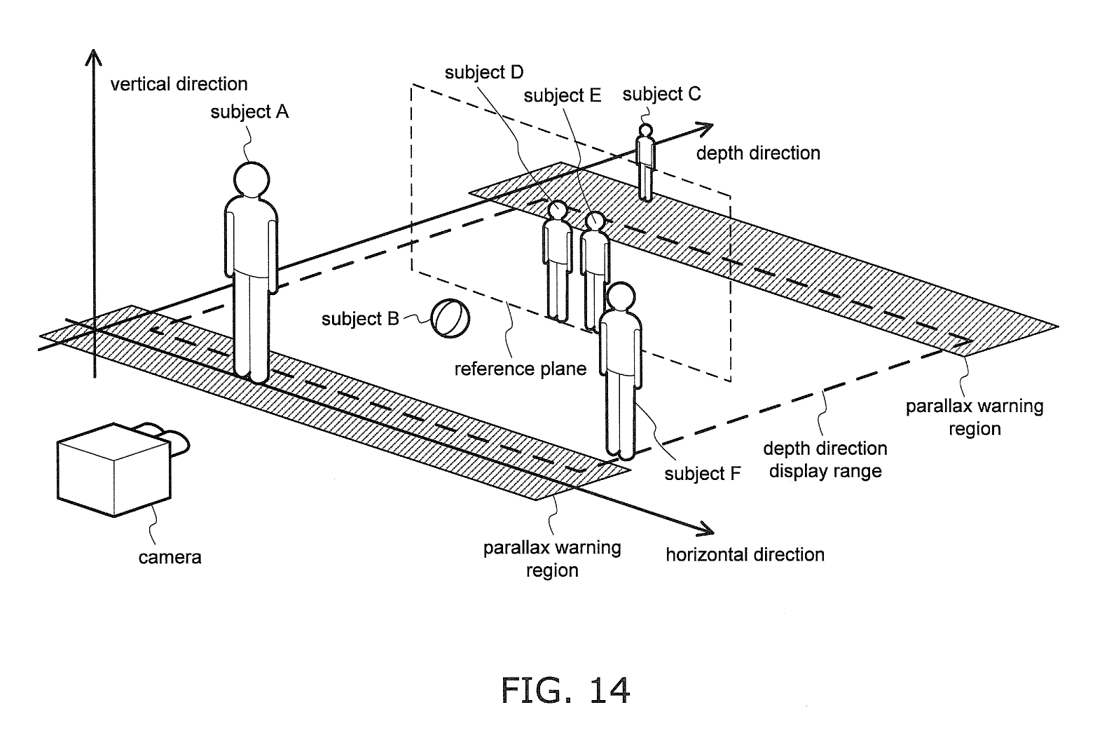

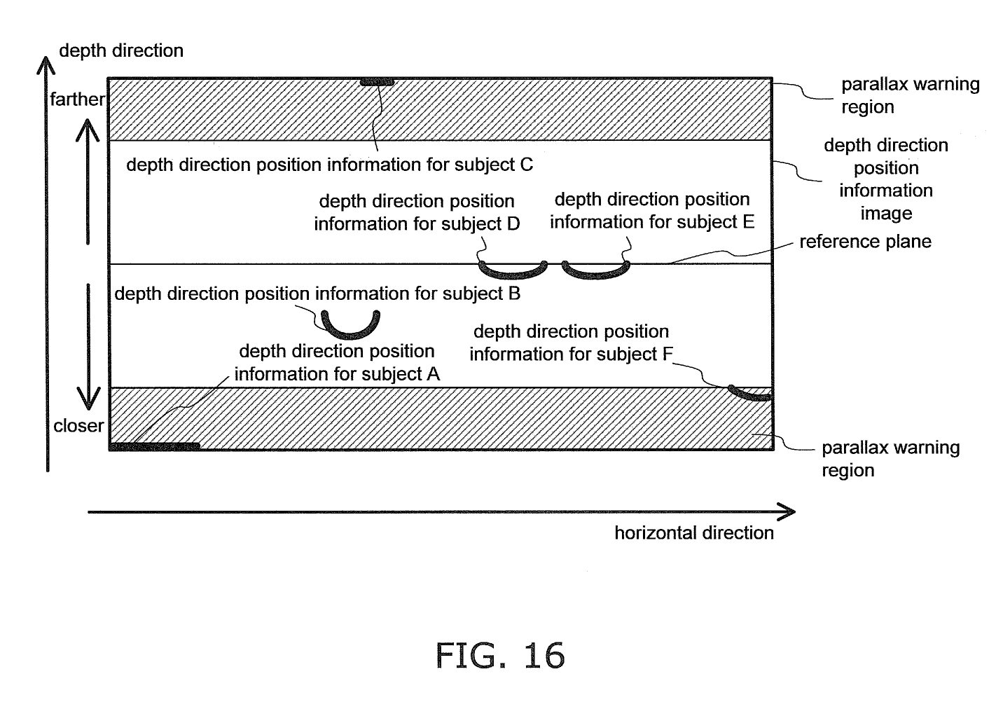

Here, the depth direction position information for subjects outside the display range may be displayed by using a different color or by flashing. This notifies the user that a subject is outside the display range. Also, within the display range of depth direction position information, if there is a range in which the parallax is too great in 3D view and causes discomfort, then this range may be set as a parallax warning region (the shaded region in FIG. 14). In this case, for example, as shown in FIG. 16, the background of the parallax warning region may be colored in, or the depth direction position information plotted in the parallax warning region may itself be displayed in a different color or flashed.

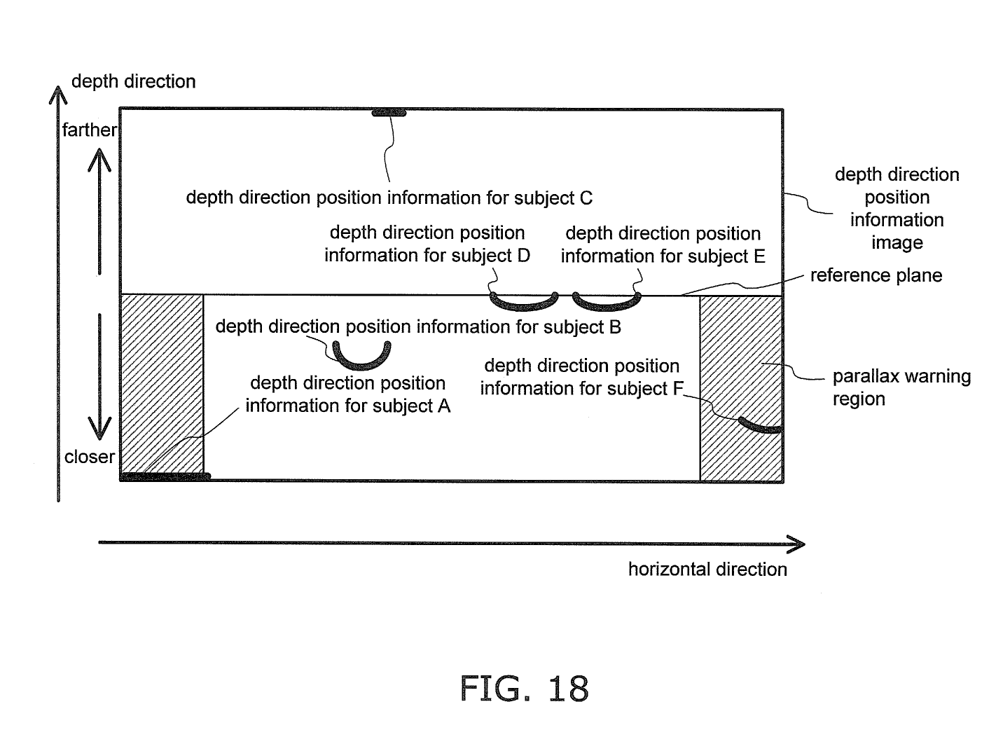

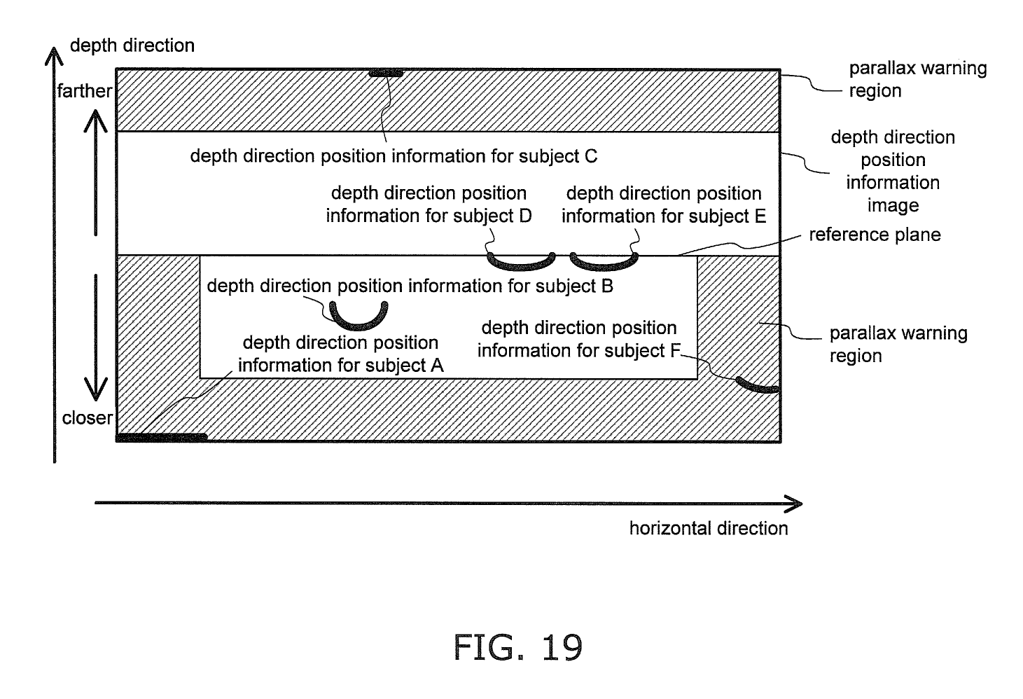

Similarly, if a subject that stands out forward in a 3D view is cut off at the edge of the screen, that range may be indicated as a parallax warning region (shaded region). Furthermore, the regions shown in FIGS. 16 and 18 (shaded regions) may be combined as shown in FIG. 19.

Thus, when a subject is outside the display range of depth direction position information, the depth direction position information for that subject is highlighted in its display, so the user can be notified in advance during 3D imaging about a subject that may cause discomfort because of excessive parallax in 3D view. Also, the depth direction position information for all subjects can be ascertained, without changing the display range of depth direction position information, by converting depth direction position information for subjects outside the display range so that they can be displayed within the display range.

(4) Setting Whether or not to use Depth Direction Position Information for a Partial Region of a Two-Dimensional Image, and Whether or not to use Depth Direction Position Information for the Entire Region of a Two-Dimensional Image

Here, for example, a region for the entire image shown in FIG. 4, corresponding to the subjects shown in FIG. 3, is set as the region for displaying the depth direction position information. In this case, as shown in FIG. 5, the depth direction position information corresponding to the subjects in the entire image is displayed as a depth direction position information image.

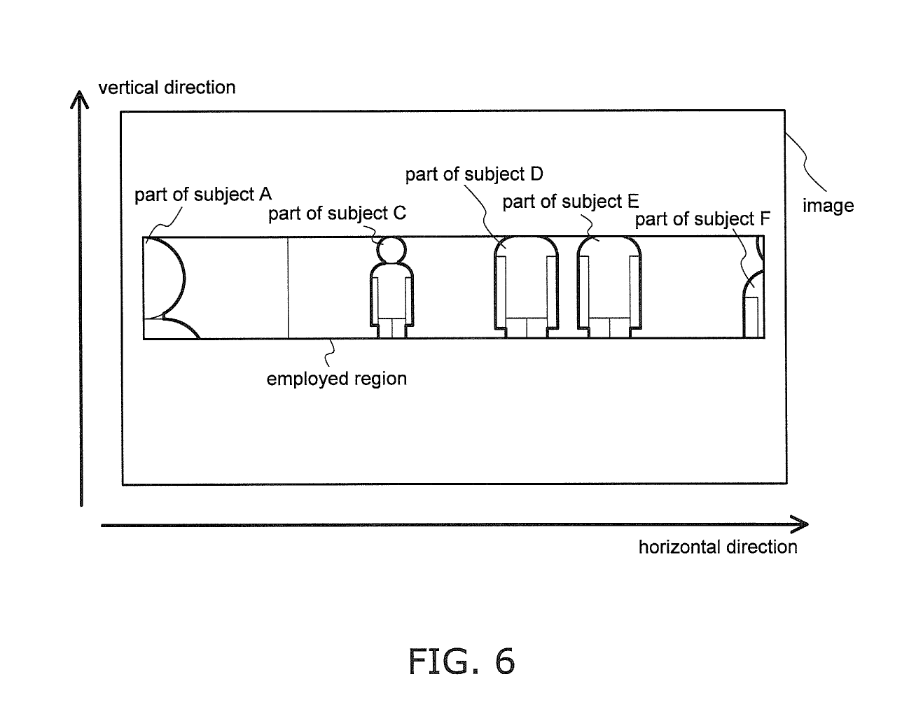

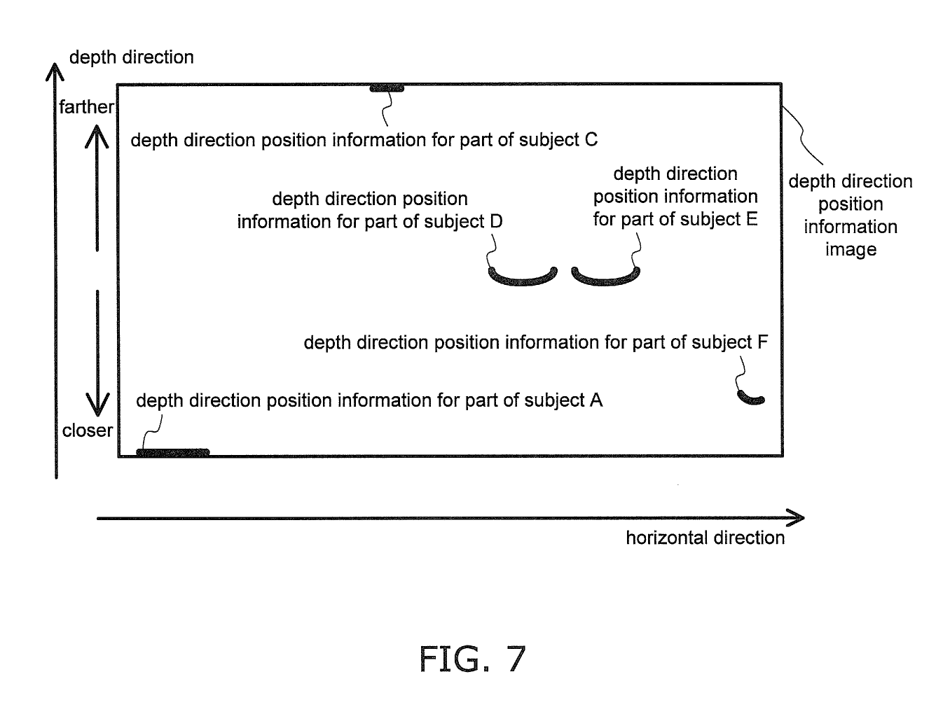

Also, here, for example, a partial region (employed region) of the image shown in FIG. 6, corresponding to the subjects shown in FIG. 3, is set as the region in which to display depth direction position information. In this case, as shown in FIG. 7, depth direction position information corresponding to the subject portion showing in the partial region of the image is displayed as the depth direction position information. In FIG. 7, the depth direction position information for subjects A and F in the employed region is only partially displayed. Also, since subject B is located outside the employed region in FIG. 6, the depth direction position information for subject B is not displayed in FIG. 7.

(5) Setting the Image Display Position and Display Size

Here, the display position and display size of an image are set. For example, setting related to combining images, setting related to switching the display of images, setting for producing an image outputted to another display device, and the like are carried out.

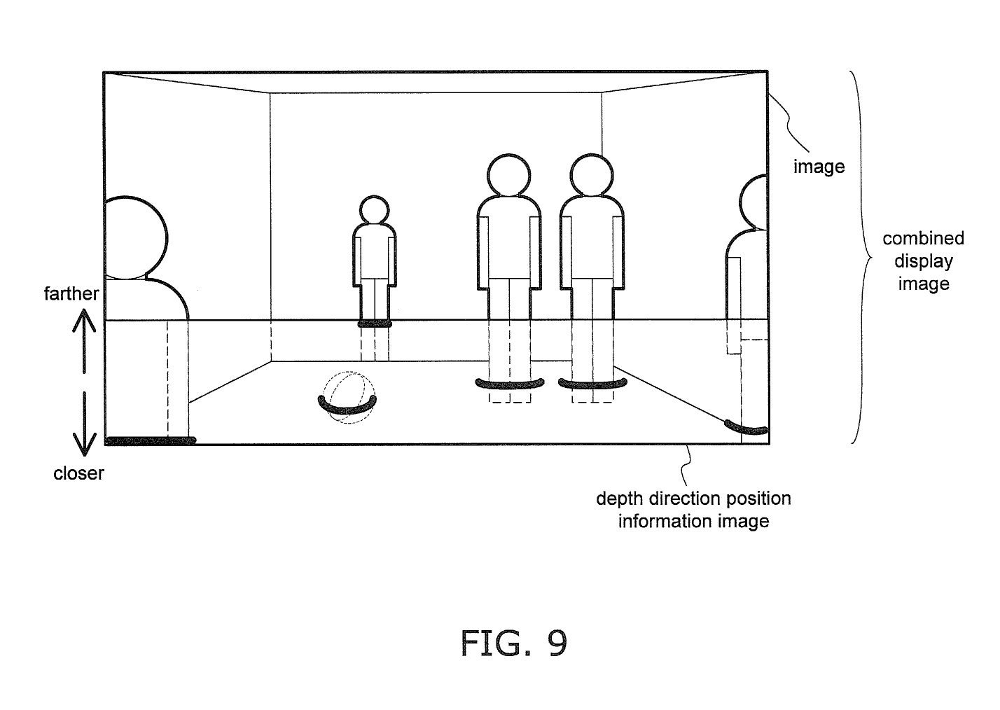

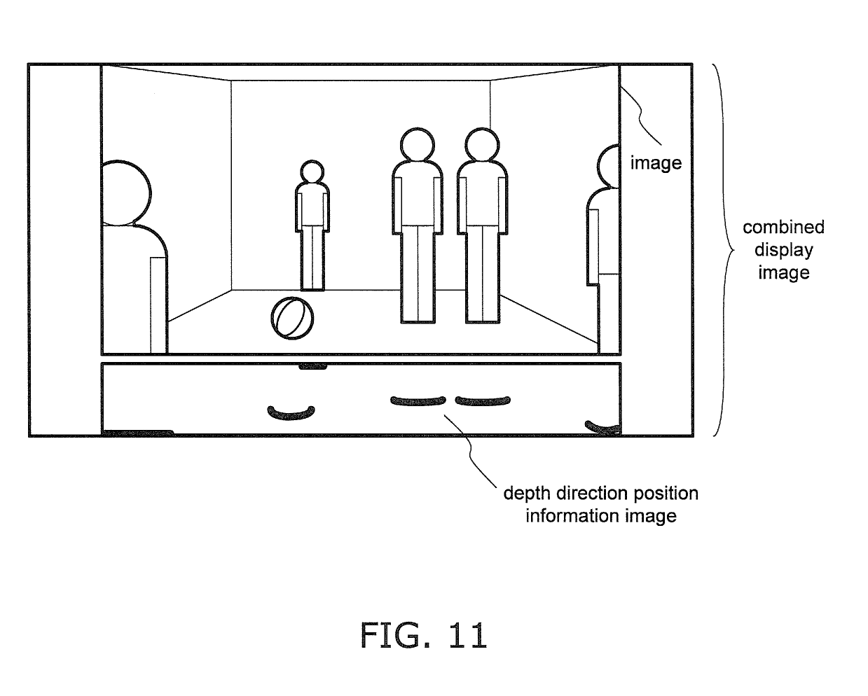

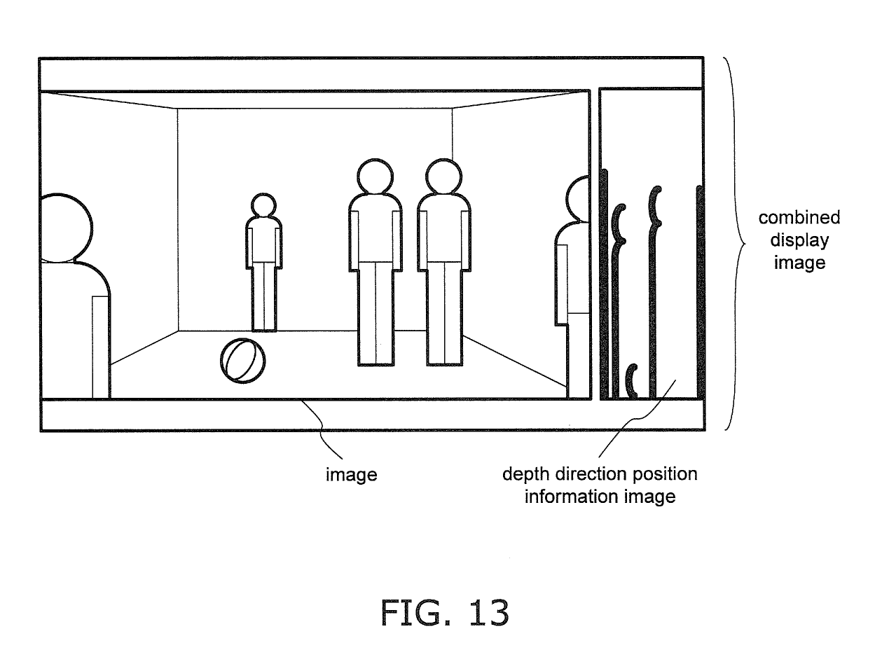

For example, a setting for displaying the entire image as shown in FIG. 4, or a setting for displaying only the part of the image in the employed region as shown in FIG. 6, is carried out. Also, as shown in FIGS. 11 and 13, a setting for the reduced display of an image, or a setting for the enlarged display of just the region to be focused on is carried out. Also, as shown in FIG. 9, setting is performed to convert either the entire image or the portion of the image overlapping the depth direction position information image into a monochromatic image. A setting is also performed to convert either the region to be focused on, or the region outside that region, to a specific color.

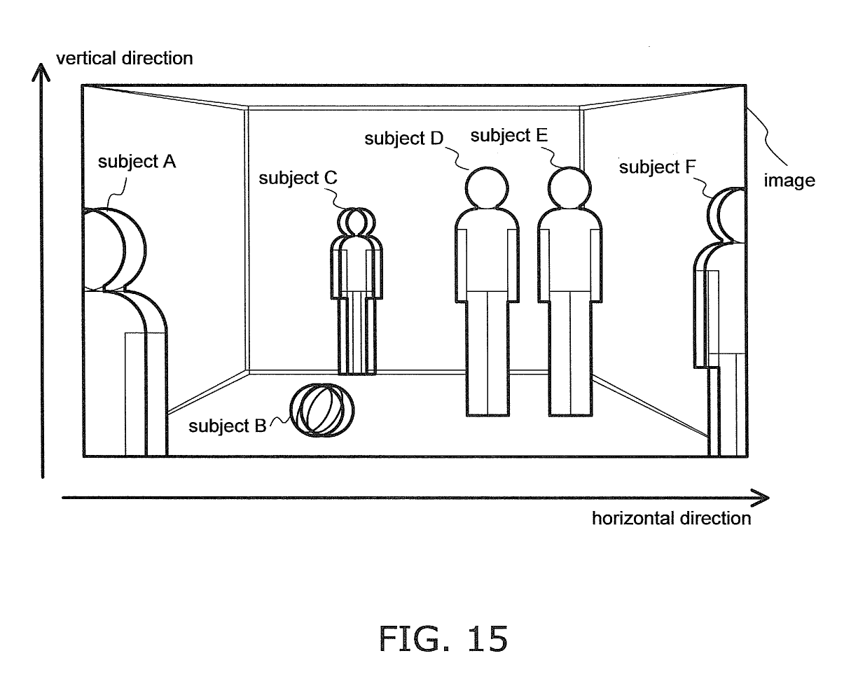

Also, as shown in FIG. 15, a setting is performed to display a superimposed left-eye image and right-eye image when an image is captured with a two-lens camera or the like. Further, when the image has three-dimensional information, a setting to produce a two-dimensional image is performed on the basis of the three-dimensional information. In this case, a setting to change the perspective position may be executed, and a two-dimensional image produced after perspective conversion.

The settings shown here are just an example, and setting of the display position of another image and setting of another display size may also be performed.

(6) Setting Whether or not to Display a Depth Direction Position Information Image as a Combination with the Image; Setting Whether to Display a Combined Display of a Depth Direction Position Information Image in a Partial Region or Superposed with the Entire Screen; and Setting the Display Position and Display Size of a Depth Direction Position Information Image

Here, whether or not to display an image as a combination with a depth direction position information image is set. For example, setting for directing the various displays given below is executed.

If there is no combination, then just the depth direction position information is displayed. In this case, the depth direction position information may be displayed on another display device besides the main display device. Also, in this case, display of the image and the depth direction position information image may be switched on a single display device.

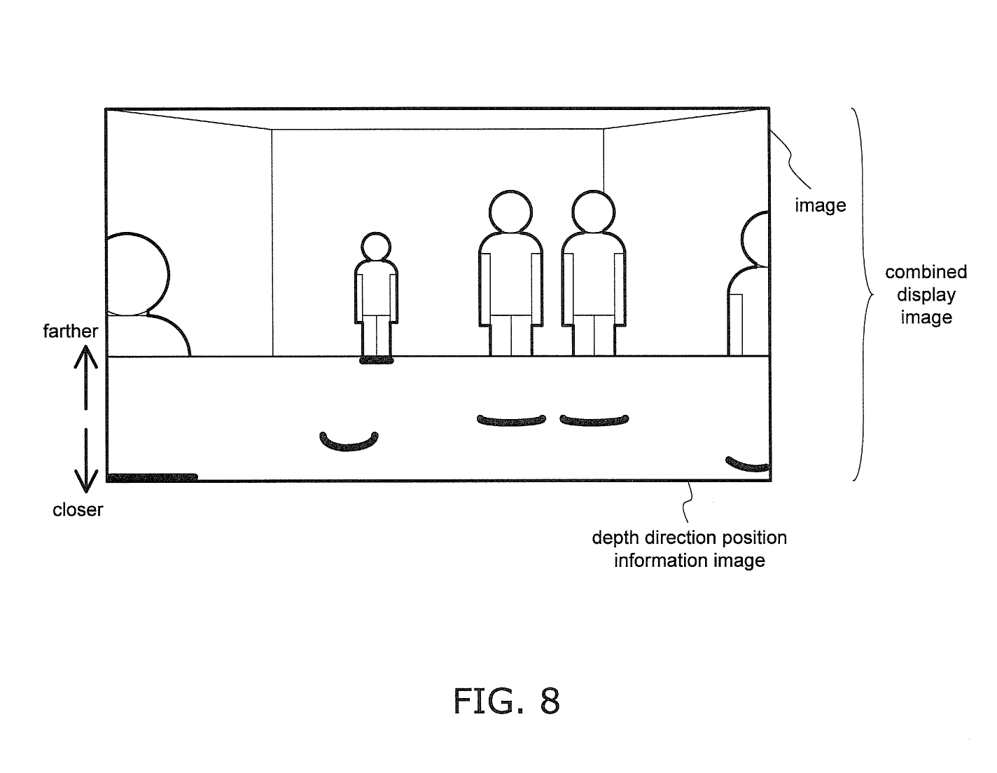

Meanwhile, for example, when the image shown in FIG. 4 is displayed as a combination with the depth direction position information image in FIG. 5, then as shown in FIG. 8, horizontal direction position information for the depth direction position information image is made to coincide with the horizontal position of the pixels of the image, so that the depth direction position information is displayed superposed with part of the image. Consequently, the relationship between the horizontal position information and the subjects can be easily ascertained. In this case, the image of subject B shown in FIG. 4 is not displayed. Accordingly, as shown in FIG. 9, the depth direction position information image may be displayed superposed as a semi-transparent layer over the image. This allows the image of subject B to be ascertained. Also, the depth direction position information image and the image may be reduced in size and displayed side by side as in FIG. 11. Also, the depth direction position information image in FIG. 5 may be converted into a semi-transparent layer and superposed over the entire image in FIG. 4.

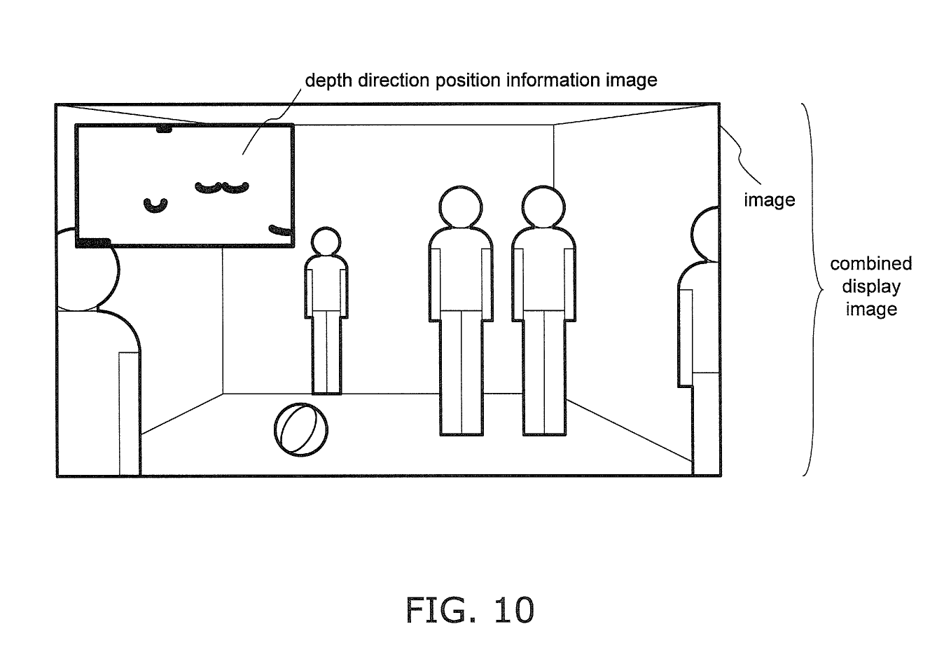

Also, when the entire configuration of the image is to be ascertained, as shown in FIG. 10, the depth direction position information image may be displayed as a sub-image superposed over part of the image. Also, the depth direction position information image shown in FIG. 12 may be displayed as a combination with the image shown in FIG. 4. In this case, for example, the combination can be as in FIG. 13, which allows the relationship between the vertical position information and the subject to be easily ascertained. Further, combination of the image shown in FIG. 4 with the depth direction position information image in FIG. 12 may be another combination display as described above.

The image processor 102 processes the image inputted from the input component 101, thereby producing a two-dimensional image, and outputs this to the display processor 104. As a result of this image processing, a two-dimensional image corresponding to the display mode set with the setting component 109 is produced. Examples of image processing include the production of a combined image in which a left-eye image and a right-eye image having binocular parallax are superposed as in the setting in (5) above, the production of a monochromatic image, the conversion of the image size, the selection of a partial display region, and the conversion of a three-dimensional image into a two-dimensional image from a certain perspective.

The depth direction position information processor 103 processes the depth direction position information outputted from the input component 101 so as to create the display set with the setting component 109, thereby producing a two-dimensional image (depth direction position information image), and outputs this to the display processor 104.

Here, the depth direction position information is processed by choosing the information required for the production of a two-dimensional image. For example, depth direction position information and the horizontal direction position information thereof, or depth direction position information and the vertical direction position information thereof, in the set region of the image set in (2) above are chosen as the information required to produce a depth direction position information image. The chosen information is subjected, for example, to conversion in which the depth direction position information is put into a specified display range as set in (3) or (5) above, or to conversion into depth direction position information corresponding to a two-dimensional image as seen from the perspective set in the three-dimensional image.

A two-dimensional image indicating depth direction position information (depth direction position information image) is produced, for example, by converting depth direction position information and the horizontal direction position information thereof into image information made up of the vertical direction and the horizontal direction, and plotting this on a two-dimensional graph. Also, a depth direction position information image is produced by converting depth direction position information and the vertical direction position information thereof into image information made up of the horizontal direction and the vertical direction, and plotting this on a two-dimensional graph. The two-dimensional image may be subjected to colorization processing, flash processing, or the like to make the graph easier to read. Also, the reference plane set in (1) above may be displayed in the two-dimensional image, for example.

The display processor 104 combines the image inputted from the image processor 102 with the image inputted from the depth direction position information processor 103 and displays the combined image. More specifically, the display processor 104 displays a combination of the image outputted by the image processor 102 and the image outputted by the depth direction position information processor 103 on the basis of the display settings at the setting component 109 and the display settings of (4) and (6) above, for example.

An example of the configuration of the depth direction position information display device in an embodiment was described above through reference to a block diagram.

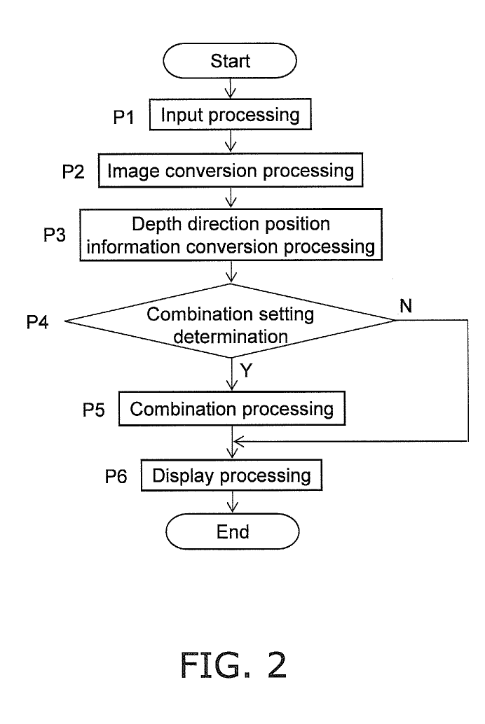

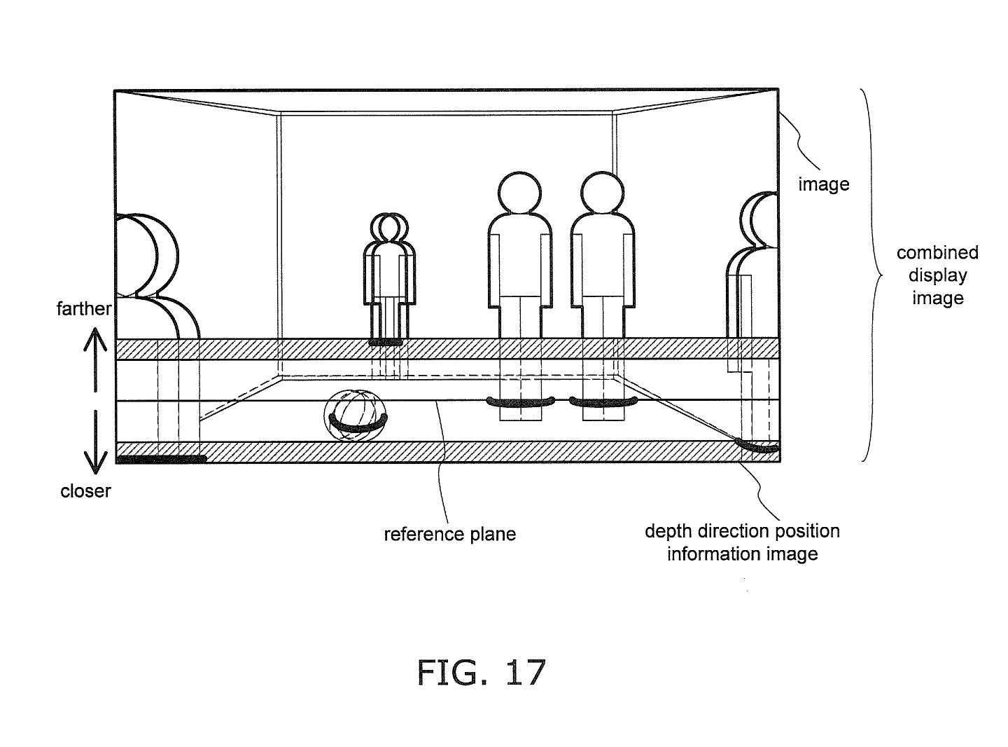

FIG. 2 is a flowchart showing an example of the operation of the depth direction position information display device in an embodiment. Here, for example, the inputted information is a left-eye image and a right-eye image having binocular parallax, and the amount of parallax for each of the pixels thereof, and processing will be described for when displaying the combination display image shown in FIG. 17 as the final display.

In this case, the setting component 109 processes as follows. First, the setting component 109 sets the depth direction position information that will serve as a reference. For instance, as shown in FIG. 14, reference plane position information is set as depth direction position information that will serve as a reference. The reference plane position information is information indicating the position where there is no binocular parallax in 3D display. Then, the setting component 109 uses the depth direction position information and the horizontal direction position information to set the display range of the depth direction position information to the range shown in FIG. 14. Here, the display range is set so that the amount of parallax will be no more than ±3% of the horizontal direction size of the image, with respect to the reference plane set by the reference plane position information. The display range shown here is the display range in the depth direction.

Next, the setting component 109 sets the parallax warning region to the range shown in FIG. 14. The setting component 109 sets the parallax warning region, for example, to the range in the depth direction of the amount of parallax that is more than +2% or less than −2% of the horizontal direction size of the image, with respect to the reference plane set by the reference plane position information. Here, the setting component 109 also performs a setting to display the parallax warning region in color.

Then, the setting component 109 uses the depth direction position information with respect to the entire region of the two-dimensional image shown in FIG. 4 to perform a setting for producing the depth direction position information image shown in FIG. 16. The setting component 109 then performs a setting for producing the combination image shown in FIG. 15, such as an image in which a left-eye image and right-eye image captured with a two-lens camera or the like are superposed. The setting component 109 then performs a setting for combining and displaying the image of FIG. 15 and the depth direction position information image of FIG. 16 as shown in FIG. 17. For example, in FIG. 17, the depth direction position information image is set to be semi-transparent, and the image and the depth direction position information image are combined and displayed so that the horizontal direction position information and the horizontal positions of the pixels of the image coincide in the lower one-third of the image.

When the above-mentioned settings are performed by the setting component 109, various processing is executed as follows on the basis of these settings.

First, in input processing P1, a left-eye image and a right-eye image having binocular parallax, and the amount of parallax for each pixel of the left-eye image and the right-eye image are inputted to the input component 101. The amount of parallax may be with respect to the left-eye image or to the right-eye image, or may be with respect to both the left-eye image and the right-eye image. Next, the input component 101 outputs the image to the image processor 102, and outputs depth direction position information to the depth direction position information processor 103. Here, the position of the depth direction position information corresponding to the image is defined by the horizontal direction position information and the vertical direction position information.

In image conversion processing P2, the image processor 102 produces an image according to the display settings of the setting component 109. For example, the image processor 102 adds the pixel values for the same position in the left-eye image and right-eye image having binocular parallax, and divides the result by two. As a result, the image processor 102 produces the image in FIG. 15. The “pixel values for the same position” here corresponds to the pixel values at the same position on a plane constituted by the horizontal direction and the vertical direction in the left-eye image and right-eye image having binocular parallax.

In FIG. 15, subject D and subject E in the reference plane have no binocular parallax, so the left-eye image and the right-eye image are displayed overlapping at the same position. Since there is binocular parallax for a subject not in the reference plane, the left-eye image and the right-eye image are displayed as a doubled image.

In depth direction position information conversion processing P3, the depth direction position information processor 103 chooses depth direction position information and the horizontal direction position information thereof with respect to the entire region of the two-dimensional image on the basis of the display settings at the setting component 109. The depth direction position information processor 103 displays the reference plane set by the reference plane position information in the above-mentioned two-dimensional graph. Also, the depth direction position information processor 103 plots in a two-dimensional graph the amount of parallax within ±3% of the horizontal direction size of the image, using this reference plane as a reference. For example, when the horizontal size of the image is 1920 pixels, the amount of parallax that is ±3% of the horizontal direction size of the image is ±58 pixels. Here, the plus side is defined in the direction of shifting horizontally to the right, and the minus side is defined in the direction of shifting horizontally to the left. In this case, the depth direction position information processor 103 plots the range over which the amount of parallax for each pixel is from +58 pixels to −58 pixels, that is, the amount of parallax in the depth direction display range, in a two-dimensional graph.

Here, for an object whose amount of parallax exceeds the depth direction display range, the amount of parallax of this object is set to the upper or lower limit value for the amount of parallax within the employed region (in this case, the total amount of parallax since the entire screen is the employed region). For example, if the amount of parallax of the object is over +58 pixels, the amount of parallax of this object is set to +58 pixels. If the amount of parallax of the object is under −58 pixels, the amount of parallax of this object is set to −58 pixels.

Also, the region corresponding to the amount of parallax outside the range of ±2% of the horizontal direction size of the image is set as the parallax warning region. For example, when the horizontal size of the image is 1920 pixels, the amount of parallax that is ±2% of the horizontal direction size of the image is ±38 pixels. In this case, the depth direction position information processor 103 plots the amount of parallax outside the range of ±38 pixels in a two-dimensional graph just as with the above-mentioned depth direction display range. The depth direction position information processor 103 then adds color, such as yellow or red, to the graph background to highlight the parallax warning region, and produces the depth direction position information image in FIG. 16.

In combination setting determination P4, it is determined whether or not a combination of the image and the depth direction position information image has been set. In this embodiment, since the display setting shown in FIG. 17 is made, the flow here proceeds to combination processing P5.

In the combination processing P5, the display processor 104 combines the image with the depth direction position information image, and produces a combined display image. For example, when the depth direction position information image is produced in full size, the display processor 104 converts the depth direction position information image to semi-transparent, and reduces the vertical axis (depth direction) size of the depth direction position information image to one-third. The display processor 104 then matches the horizontal direction position information of the depth direction position information image with the horizontal position of the pixels of the image in the lower one-third region of the image. As a result, the converted depth direction position information image is superposed with the lower one-third region of the image, and a combined display image is produced. More precisely, the image brightness is increased in the lower one-third region of the image, the pixel values for the same position are added in the converted depth direction position information image and the image with increased brightness, and this result is divided by two. This processing produces a combined display image.

In display processing P6, the display processor 104 displays the combined image produced in the combination processing P5. Consequently, for example, an image corresponding to the display setting at the setting component 109 is displayed.

An example of the operation of a depth direction position information display device in an embodiment was described above through reference to a flowchart.

The various settings and processing performed with the above-mentioned depth direction position information display device 100 can be executed by a controller (not shown). This controller may be made up of a ROM (read only memory) and a CPU, for example. The ROM holds programs for executing various settings and processing. The controller has the CPU execute the programs in the ROM, and thereby controls the settings and processing of the input component 101, the image processor 102, the depth direction position information processor 103, the display processor 104, and the setting component 109. When the various settings and processing are executed, a recording component (not shown) such as a RAM (random access memory) is used for temporarily storing the data.

With the above-mentioned depth direction position information display device 100, information in the depth direction can be accurately and easily recognized. Also, object cropping adjustment of the display screen edges, reference plane adjustment, and so forth can be easily carried out on the basis of this information in the depth direction. Furthermore, the depth direction position information image can be used to notify the user during imaging so that a subject is not in the parallax warning region, or to correct a recorded image, or to adjust the depth direction position information of a reference plane in which there is no left and right parallax.

### Other Embodiments

(a) In the above embodiment, the amount of parallax for each pixel was used as depth direction position information, but the amount of parallax for each block, each region, or each subject may be used instead as depth direction position information. Also, a person, thing, or other such subject was used as the object to simplify the description, but processing can be performed as discussed above on all subjects having parallax. For example, as shown in FIG. 15, processing can be similarly performed on a wall or other such background.

(b) In the above embodiment, an example was given in which a display image was produced by superposing the left-eye image and right-eye image as shown in FIG. 15, but just part of the image, such as either the left-eye image or the right-eye image, may be used as the display image.

(c) In the above embodiment, depth direction position information may be reported by incorporating a measure that indicates depth distance (a meter, pixel count, etc.) into the depth direction position information image. This allows the user to easily grasp the depth direction position information.

(d) In the above embodiment, an example was given in which a combined image was produced by a mean superposition of the left-eye image and right-eye image, but how the combined image is produced is not limited to what is given in the above embodiment, and the image may be produced in any way. For instance, a combined image may be produced by alternately displaying the left-eye image and right-eye image at high speed. Or, a combined image may be produced by superposing the left-eye image and right-eye image once every line.

(e) In the above embodiment, the setting component 109 made settings related to the display of depth direction position information, but the settings related to the display of depth direction position information are not limited to what was given in (1) to (6) above, and any such settings may be made. The device can be made to operate according to the settings even if the settings related to the display of depth direction position information are made in a different mode from what was given in (1) to (6) above.

(f) In the above embodiment, an example was given in which depth direction position information was inputted to the input component 101, but depth direction position information may be produced on the basis of an image inputted to the input component 101.

(g) In the above embodiment, an example was given in which the horizontal direction position information included a horizontal direction coordinate (such as an x coordinate), the vertical direction position information included a vertical direction coordinate (such as a y coordinate), and the depth direction position information included a depth direction coordinate (such as a z coordinate). Specifically, in the above embodiment, in the above embodiment, three-dimensional position information about the image was defined in a three-dimensional orthogonal coordinate system, but the three-dimensional position information about the image may be defined in some other way. For example, three-dimensional position information about the image may be defined by a polar coordinate system composed of the distance r from a reference point, the angle θ around the reference point, and the height y from the reference point. The reference point (home point) can be set as desired.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a display device and a display method. Accordingly, these terms, as utilized to describe the present technology should be interpreted relative to a display device and a display method.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technology are provided for illustration only, and not for the purpose of limiting the technology as defined by the appended claims and their equivalents.

### INDUSTRIAL APPLICABILITY

The technology disclosed herein can be broadly applied to display devices that display information about a three-dimensional image.

1. A display device comprising:
an input unit to which depth direction position information is inputted, the depth direction position information corresponding to information about the depth direction of a subject and/or the position in the depth direction of the subject, the depth direction position information set for at least part of a two-dimensional image corresponding to the subject;
a depth direction position information processing unit configured to process two-dimensional information, the two-dimensional information made up of the depth direction position information and either horizontal direction position information or vertical direction position information, the horizontal direction position information corresponding to the position of the subject in the horizontal direction and being set for at least part of the two-dimensional image, the vertical direction position information corresponding to the position of the subject in the vertical direction and being set for at least part of the two-dimensional image; and
a display processing unit configured to display an image corresponding to the two-dimensional information processed by the depth direction position information processing unit.

2. The display device according to claim 1, wherein
the depth direction position information has position information indicating the position of the two-dimensional image in the depth direction and/or relative distance information about the two-dimensional image.

3. The display device according to any-of claim 1, further comprising:
an image processing unit configured to convert at least part of a subject image inputted to the input unit into a two-dimensional image, wherein
the depth direction position information processing unit processes the two-dimensional information corresponding to at least part of the subject image, and
the display processing unit displays the two-dimensional image converted by the image processing unit and/or an image corresponding to the two-dimensional information which corresponds to at least part of the subject image.

4. The display device according to claim 1, wherein
the depth direction position information processing unit sets a reference plane for defining the depth direction position information, in the image corresponding to the two-dimensional information.

5. The display device according to claim 4, wherein
the reference plane is set to a position where there is no binocular parallax when the image is displayed three-dimensionally, and
the depth direction position information processing unit displays the reference plane in the image corresponding to the two-dimensional information.

6. The display device according to claim 1, wherein
the depth direction position information processing unit changes the display mode within a specific range of the depth direction position information in an image corresponding to the two-dimensional information.

7. The display device according to claim 1, wherein
the depth direction position information processing unit sets the depth direction position information to a specific value when the depth direction position information exceeds the specific value in an image corresponding to the two-dimensional information.

8. A display device, comprising:
an input unit to which a subject image is inputted;
a depth direction position information processing unit configured to calculate depth direction position information on the basis of the subject image, the depth direction position information corresponding to information about the depth direction of a subject and/or the position in the depth direction of the subject, the depth direction position information set for at least part of the two-dimensional image corresponding to the subject, and configured to process two-dimensional information, the two-dimensional information made up of the depth direction position information and either horizontal direction position information or vertical direction position information, the horizontal direction position information corresponding to the position of the subject in the horizontal direction and being set for at least part of the two-dimensional image, the vertical direction position information corresponding to the position of the subject in the vertical direction and being set for at least part of the two-dimensional image; and
a display processing unit configured to display an image corresponding to the two-dimensional information processed by the depth direction position information processing unit.

9. The display device according to claim 8, wherein
the depth direction position information has position information indicating the position of the two-dimensional image in the depth direction and/or relative distance information about the two-dimensional image.

10. The display device according to claim 8, further comprising:
an image processing unit configured to convert at least part of a subject image inputted to the input unit into a two-dimensional image, wherein
the depth direction position information processing unit processes the two-dimensional information corresponding to at least part of the subject image, and
the display processing unit displays the two-dimensional image converted by the image processing unit and/or an image corresponding to the two-dimensional information which corresponds to at least part of the subject image.

11. The display device according to claim 8, wherein
the depth direction position information processing unit sets a reference plane for defining the depth direction position information, in the image corresponding to the two-dimensional information.

12. The display device according to claim 11, wherein
the reference plane is set to a position where there is no binocular parallax when the image is displayed three-dimensionally, and
the depth direction position information processing unit displays the reference plane in the image corresponding to the two-dimensional information.

13. The display device according to claim 8, wherein
the depth direction position information processing unit changes the display mode within a specific range of the depth direction position information in an image corresponding to the two-dimensional information.

14. The display device according to claim 8, wherein
the depth direction position information processing unit sets the depth direction position information to a specific value when the depth direction position information exceeds the specific value in an image corresponding to the two-dimensional information.

15. A display method comprising:
an input step to which depth direction position information is inputted, the depth direction position information corresponding to information about the depth direction of a subject and/or the position in the depth direction of the subject, the depth direction position information set for at least part of a two-dimensional image corresponding to the subject;
a depth direction position information processing step of processing two-dimensional information, the two-dimensional information made up of the depth direction position information and either horizontal direction position information or vertical direction position information, the horizontal direction position information corresponding to the position of the subject in the horizontal direction and being set for at least part of the two-dimensional image, the vertical direction position information corresponding to the position of the subject in the vertical direction and being set for at least part of the two-dimensional image; and
a display processing step of displaying an image corresponding to the two-dimensional information processed by the depth direction position information processing unit.

16. A display method comprising:
an input step to which a subject image is inputted;
a depth direction position information processing step of calculating depth direction position information on the basis of the subject image, the depth direction position information corresponding to information about the depth direction of a subject and/or the position in the depth direction of the subject, the depth direction position information set for at least part of the two-dimensional image corresponding to the subject, and configured to process two-dimensional information, the two-dimensional information made up of the depth direction position information and either horizontal direction position information or vertical direction position information, the horizontal direction position information corresponding to the position of the subject in the horizontal direction and being set for at least part of the two-dimensional image, the vertical direction position information corresponding to the position of the subject in the vertical direction and being set for at least part of the two-dimensional image; and
a display processing step of displaying an image corresponding to the two-dimensional information processed by the depth direction position information processing unit.
